(19) United States
(12) Patent Application Publication
(10) Pub. No.: US 2014/0105752 A1
(43) Pub. Date: Apr. 17, 2014

(54) DRUM POUCH WIND TURBINE

(71) Applicant: STEVEN JAMES ANDREWS, GUATEMALA (GT)

(72) Inventor: STEVEN JAMES ANDREWS, GUATEMALA (GT)

(73) Assignee: STEVEN JAMES ANDREWS, GUATEMALA (GT)

(21) Appl. No.: 13/651,392

(22) Filed: Oct. 13, 2012

(51) Int. Cl. F01D 5/14; F03B 3/12; F03D 3/06

(52) U.S. Cl. 416/241 R

(57) ABSTRACT

The Drum Pouch Wind Turbine consists of drum shaped cage structures wrapped with fabric pouches all around the perimeter which catch the wind on one side. The pouches may be stretched between two rings, one ring on each end. The system may consist of at least two drum impellers, one drum rotating clockwise and the other counter clockwise, doubling the relative rotational velocity between each pair of drums and having double the torque (because of the counter rotation), thereby increasing power output with the same wind speed. In essence, the system is composed of two counter rotating impellers and one generator, one portion of the generator on each drum.

### REFERENCES

| Pat No. | Appl. | |
|---|---|---|
| U.S. Pat. No. 3,918,839 | Sep. 20, 1974 | '75 |
| U.S. Pat. No. 4,088,352 | Mar. 25, 1975 | May 09, 1978 |
| U.S. Pat. No. 4,168,439 | Nov. 28, 1977 | Sep. 18, 1979 |
| U.S. Pat. No. 4,289,970 | Nov. 22, 1978 | Sep. 15, 1981 |
| U.S. Pat. No. 4,311,918 | Aug. 07, 1980 | Jan. 19, 1982 |
| U.S. Pat. No. 4,330,714 | Jun. 26, 1980 | May 18, 1982 |
| U.S. Pat. No. 4,334,823 | Dec. 16, 1980 | Jun. 15, 1982 |
| U.S. Pat. No. 4,342,539 | Feb. 13, 1979 | Aug. 03, 1982 |
| U.S. Pat. No. 4,449,053 | Jul. 27, 1981 | May 05, 1984 |
| U.S. Pat. No. 4,624,624 | Mar. 25, 1985 | Nov. 25, 1986 |
| U.S. Pat. No. 4,720,640 | Sep. 23, 1985 | Jan. 19, 1988 |
| U.S. Pat. No. 5,171,127 | | Dec. 15, 1994 |
| U.S. Pat. No. 5,315,959 | May 06, 1992 | May 24, 1994 |
| U.S. Pat. No. 6,700,216 | Mar. 03, 2003 | Mar. 02, 2004 |
| U.S. Pat. No. 6,979,170 | Jan. 24, 2003 | Dec. 27, 2005 |
| U.S. Pat. No. 7,109,599 | May 05, 2004 | Sep. 19, 2006 |
| U.S. Pat. No. 7,116,006 | Sep. 16, 2005 | Oct. 03, 2006 |
| U.S. Pat. No. 8,102,073 | Sep. 20, 2010 | Jan. 24, 2012 |
| U.S. Pat. No. 7,215,038 | Jul. 26, 2005 | May 08, 2007 |
| U.S. Pat. No. 7,241,105 | May 23, 2003 | Jul. 10, 2007 |
| U.S. Pat. No. 7,303,369 | Oct. 31, 2005 | Dec. 04, 2007 |
| U.S. Pat. No. 7,448,337 | Feb. 21, 2007 | Nov. 11, 2008 |
| U.S. Pat. No. 7,582,982 | Aug. 27, 2008 | Sep. 01, 2009 |
| U.S. Pat. No. 7,604,454 | Oct. 09, 2008 | Oct. 20, 2009 |
| U.S. Pat. No. 7,605,486 | Apr. 15, 2008 | Oct. 20, 2009 |
| U.S. Pat. No. 7,638,895 | Jul. 16, 2007 | Dec. 29, 2009 |
| U.S. Pat. No. 7,794,205 | Feb. 20, 2007 | Sep. 14, 2010 |
| U.S. Pat. No. 7,825,532 | Apr. 30, 2009 | Nov. 02, 2010 |
| U.S. Pat. No. 7,905,447 | Nov. 16, 2007 | Mar. 15, 2011 |
| U.S. Pat. No. 7,927,065 | Sep. 02, 2009 | Apr. 19, 2011 |
| U.S. Pat. No. 7,944,969 | Aug. 13, 2008 | May 17, 2011 |
| U.S. Pat. No. 7,948,111 | Nov. 26, 2008 | May 24, 2011 |
| U.S. Pat. No. 7,964,978 | Oct. 06, 2008 | Jun. 21, 2011 |
| U.S. Pat. No. 7,980,823 | Oct. 27, 2008 | Jul. 19, 2011 |
| U.S. Pat. No. 8,049,351 | Jun. 13, 2008 | Nov. 01, 2011 |

### BACKGROUND OF THE INVENTION

Currently the global concern surrounding the increasing costs of oil derived energy and the climate change unrest, plus the increasing demand of energy around the world, especially in developing countries, the pressure to find new sources of energy is getting to be of the foremost urgency.

Lately, the devastation of infrastructures by earthquakes or other natural disasters in countries around the world has highlighted the need of energy systems which are easy to transport, install and deploy without the need of complex infrastructures and which can meet energy demands for field hospitals and other low demand situations as well as being cheap and low tech.

### FIELD OF THE INVENTION

The present invention is concerned with an improved hydro/aero electric turbine manufactured for easy assembly and deployment. It may be sold in unit boxes to be stacked or grouped into larger systems very easily and installed in very different ways by untrained people. A small system may be packed unassembled or knock down and boxed to be shipped by mail, transported and deployed without needing infrastructure.

The vertical axis turbine works in turbulent wind and in tight or wide spaces, does not need to be directed into the wind, can be stacked or grouped very easily. In one embodiment it uses simple, cheap generators if necessary or small wheeled generators mounted around the perimeter and riding over circular rails on the second drum impeller.

This invention is intended to supply a broad population with economical and easy to install wind turbines from micro to macro generation of electricity. To be used by emergency teams in off grid situations, natural disasters, the military, or to satisfy a demand not met by other systems in developing countries.

### BRIEF SUMMARY

A system consisting of at least two drum shaped cage structures wrapped with fabric pouches all around the perimeter which catch the wind on one side. The pouches may be stretched between two rings, one ring on each end.

The first pair of stacked drum impellers, one drum rotating clockwise and the other counter clockwise, doubling the relative rotational velocity between each pair of drums and having double the torque (one portion of the generator on each impeller), thereby increasing power output with the same wind speed.

In essence, the system is composed by two counter rotating impellers and one generator.

The drum shaped impellers, the split jackets and split bearings may be split in two halves and hinged so they may be overlaid over a tubular structure, a long rod, a pole or tensed cable and raised to operating height when ready.

The system may be deployed over existing columns, guy wires or over flowing water currents, on existing cell phone towers or flag or light poles.

The generators may be installed around the periphery of the drum impellers, as that is the highest speed location.

In one embodiment, the drum cages fit over a wide base tower. The wide throat of the drum impellers may ride over ring shaped static maglev bearings which may be supported by radially extending beams to the tower, which serves as a vertical rotation axis.

The drum impellers may be stacked one on top of the other, with one drum rotating clockwise while the upper drum rotating counterclockwise. Between the drum impellers there may be a maglev ring generator-bearing, with the rotor portion rotating on one impeller while the stator portion counter rotating on the other drum impeller as in the “Inducktrack” system.

In another embodiment it may use simple, small wheeled generators mounted around the perimeter and riding over circular rails on the second drum impeller. As another boosting feature, the drums may be equipped with extendable arms with paddles or frames with sails that extend the reach of the drums on one side and retract on the other side accelerating rotation as the arms retract and also to reduce wind exposure. This feature enlarges the caption area and the torque on the system.

Another feature may be triangular prism shaped fluid stream deflectors, to deflect oncoming fluid into pouches and extendable arm sails on one side to increase incoming fluid on the sides of the impellers and reduce wind exposure on the other.

### DESCRIPTION

The Drum Pouch Wind Turbine consists of drum shaped cage structures wrapped with fabric pouches all around the perimeter, open on one side to catch the wind. The pouches may be stretched between two rings, separated by a vertically split tubular jacket one ring on each end.

The drums may be split in two halves and hinged, so they may open over an existing column a vertical structure or a tensed cable on a guy wire or a cable bridge.

The split jacket may have a split bearing set and a split slip ring to carry the current from the rotating drums to the central column or cable. The split tubular jacket isolates the rotating drums from the central column, which is fixed to the ground or stable platform.

In essence the drums consist of the central core, the column, then, the split tubular jacket which is attached to the vertical structure, thirdly, the rotating collar may be riding over the split jackets and over bearings and lastly, the drums, with the pouches, which carry the generators around the perimeter of the drum impellers, one portion over the bottom ring of the upper impeller and the other portion on the upper ring of the lower impeller.

Each drum may be supported by radially extending beams projecting outwards from the tubular jacket, which may have a split maglev ring bearing or split pin bearing covered by another ring jacket or collar to support the star structure. Other forms of power take off are possible using the ring rails and wheeled or geared generators to support the impellers and to generate the power at the same time.

Each drum is then fixed over the central tensed cable or column by the split tubular jacket, the next drum is stacked on top. The ends of the split jackets plug into each other to define the gap between adjacent drums.

The central tower may be a pole, an open truss tower, triangular or square base or even a tensed cable which support the circular rails or ring generators.

In one embodiment, the rings on the drums may be direct drive maglev ring generators, one impeller may have the stator portion and the other the rotor portion. The rings may be at the widest part of the drums, where the rotational velocity of the system is the fastest, and the structural support the widest, leaving the center a space for the supporting tower.

In another embodiment, one drum, with a circular rail rotating in one direction, the other drum may carry the wheeled or geared generators, radially displaced in a star formation riding on the circular rails over the first drum, but rotating in the other direction thereby increasing the power output.

The drum impellers may be stacked one on top of the other, one drum rotating clockwise, the next rotating counter clockwise, the third, rotating clockwise as the first, the fourth drum rotating counter clockwise as the second, and so forth. The proximate ends of the first pair of drums may carry a set of rotor-stator portions at one end, with the third drum carrying the next set of rotor-stator portions with the second drum. The third impeller doubles the power output of the first pair; the addition of a fourth impeller triples the power output. Each pair of counter rotating drums cancels the torque forces on the central column.

In one embodiment the system may have a triangular prism shaped deflector with a directional sail behind to steer it into the wind which deflects the flow of the fluid to both sides of the impellers, which reduces the frontal exposure and redirects the flow to the pouches on the sides, boosting the volume of fluid it can use to rotate the impellers.

In another boosting feature, the drums may be equipped with extendable/retractable arms with paddles or frames with sails that extend the reach of the drums on one side and retract over on the other side accelerating rotation as the arms retract and also to reduce wind exposure. This feature enlarges the caption area and the torque on the system, and, as the drum impellers have a smaller diameter, the rotation accelerates when the extendable arms retract, boosting the power output even more.

In yet another embodiment, the counter rotating drum wind turbines may be lofted on a lighter than air heliostat, with the counter rotating drum impellers set on the tether cable, which may be anchored to the ground by cables, which transfer the current and hold to the ground or base.

Heavy wire, steel tubing, fiberglass or other strong and light synthetic material may be used to fabricate the modules, depending on the size of the units.

Low tech construction and light weight are features that enable this system to be transportable, cheap, easy to assemble and repair, easy to install.

The system may be set up on an inclined angle as on a guy wire or horizontally between two structures, or may also be used in flowing water; the system does not have to be directed into the currents, as they are set perpendicular to them. The drums may be transported in a collapsed way, without the split tubular jackets and vertical stiffening members attached for shipping and storing, or for assembly at the deployment site.

This system is highly transportable, light weight, scalable, and adaptable.

### PRIOR ART

1.—Dieter Sauer, U.S. Pat. No. D638,358, and U.S. Pat. No. 7,798,766 B, invented the WindCharger, a three blade Vertical axis turbine, based on the Savonius type, with cupped sails which have an air foil about the outer edges, which he calls torque converters to recapture the vortex air flow, which gives the system low startup and maintain higher revolutions.

The WindCharger is similar to the pouch drum turbine in the curvature of the sail arms, but the WindCharger has rigid sails, the Pouch Drum Wind Turbine (PDWT) has flexible membranes as sails; they also are similar in the outer edge air foil to capture the vortex to accelerate the rotation of the drums.

The Pouch Drum Wind Turbine has the additional advantage of retracting the sail arms on the downwind side to reduce exposure and add rotational velocity.

The Pouch Drum Wind Turbine is a system with two drums, counter rotating and each drum carrying one portion of the generator; two drums with one generator.

The Pouch Drum Wind Turbine also may use several types of generators on gears or wheels and magnetically levitated ring generators set on the ends of the adjacent drums, and may be stacked beginning with one pair and add another drum or more to increase the power of the system.

The Pouch Drum Wind Turbine may be deployed using tensed cables, guy wires, existing structures or custom made. They may be deployed on heliostats, over water currents, horizontally, diagonally or vertically if necessary.

2.—The Hydrokinetic Jet turbines, or RotoJet designs, or Axial Flow Wind Hydro Kinetic Turbine, have peripheral semi channel foils to accelerate rotation and to avoid blade energy losses. This system design bases its function using rigid blades. The rotojet designs are basically improved rotors. The inventor claims to exceed the Betz limit of extractable energy.

The RotaJet's system is applied to the known Darrieus type propeller shapes.

3.—Mr. Albert Brendel designed a counter rotating turbine out of “U” shaped concave blades which supposed to divert currents into the upper and lower blades as they passed one another, but didn't work. The system used a central shaft with a tubular jacket and gears to counter rotate the same axis; no mention of generators, bearings.

4.—Dean Kamen invented the inflatable wind turbine, where the rotors are stretched rotors with no further difference.

5.—The vertical shaft, horizontally driven, shrouded wind/electric system, U.S. Pat. No. 8,004,101which apparently has a maglev ring generator, but the system has only one rotor, not two counter rotating impellers, and the rotor blades are fixed around the perimeter of the drum shaped impeller.

6.—The Astralux vertical axis wind turbine has also a maglev ring generator around its perimeter, but is a single rotor riding over a fixed stator.

7.—The Vertical Axis Turbine, invented by Matthew Luethi, patent application US 2008/0260532 is a single drum shaped impeller with adjustable blades, but do not contemplate counter rotation of two or more impellers to boost power output.

The features that set The Pouch Drum Wind Turbine apart are in particular:

1.—The split system that may be set over an existing cable, pole or column and can be packet knocked down, easily transported and assembled in the field.

2.—A system of two or more counter rotating drums, one drum impeller containing one portion of the ring generator and the other the other portion set on each adjacent ends of the impellers.

3.—The extendable arms with sails to boost torque, caption area and accelerate rotation.

BRIEF DESCRITION OF DRAWINGS:

A.- SPLIT COLUMN JACKET
B.- SPLIT COLUMN JACKET HINGES
C.- CENTRAL COLUMN
D.- SPLIT COLLAR BEARINGS
E.- SPLIT DRUM SHAPED DRUM IMPELLERS
F.- RADIAL BEAMS SUPPORTING RINGS
G.- WHEELED/GEARED GENERATORS
H.- RING MAGLEV BEARINGS
I.- MAGLEV RING DIRECT DRIVE GENERATOR/BEARINGS
J.- MEMBRANE POUCHES
K.- EXTENDABLE ARM SAILS
L- HYDRO IMPELLERS
M.- FLUID DEFLECTORS (UPSTREAM AND DOWN STREAM)
N.- EXTENDABLE ARMS
O.-RINGED RAIL ON LOWER DRUM
P.- UPPER DRUM'S RING
Q.- THORUS HELIOSTAT, NO SCALE FOR CLARIFICATION

### DESCRIPTION OF DRAWINGS

FIG. 1=DRUM POUCH CAGES WITH SPLIT TUBULAR JACKETS″A″,

AND CLOSED DRUM CAGES. FRONT VIEW

FIG. 2=DRUM POUCH CAGES WITH RADIAL SUPPORTING BEAMS “F”,

JACKETS AND DRUMS CLOSED. ISOMETRIC FRONT VIEW

FIG. 3=INNER RINGS WITH RADIALLY DISPOSED WHEELED GENERATORS

FIG. 4=INNER RINGS WITH EXTENDABLE ARMS WITH SAILS AND TUBULAR JACKET “A” WITH BEARING COLLARS

FIG. 5=ISOMETRIC FRONT VIEW OF COUNTER ROTATING DRUM IMPELLERS AND WIND FLOW AND FRONT DEFLECTOR “M”.

FIG. 6=ISOMETRIC FRONT VIEW OF 3 DRUM SYSTEM WITH FRONT

REFLECTOR “M” AND WIND FLOW.

FIG. 7=FRONT ISOMETRIC VIEW WITH FLOW ILLUSTRATED.

FIG. 8=PLAN VIEW WITH FLOW ILLUSTRATED.

FIGS. 9+10=ISOMETRIC SIDE VIEW OF SYSTEM ON HELIOSTAT THORUS “Q”.

FIG. 11=ISOMETRIC SIDE VIEW OF HYDRO SYSTEM, UP FLOW TIDE.

FIG. 12=ISOMETRIC SIDE VIEW OF HYDRO SYSTEM, DOWN FLOW TIDE.

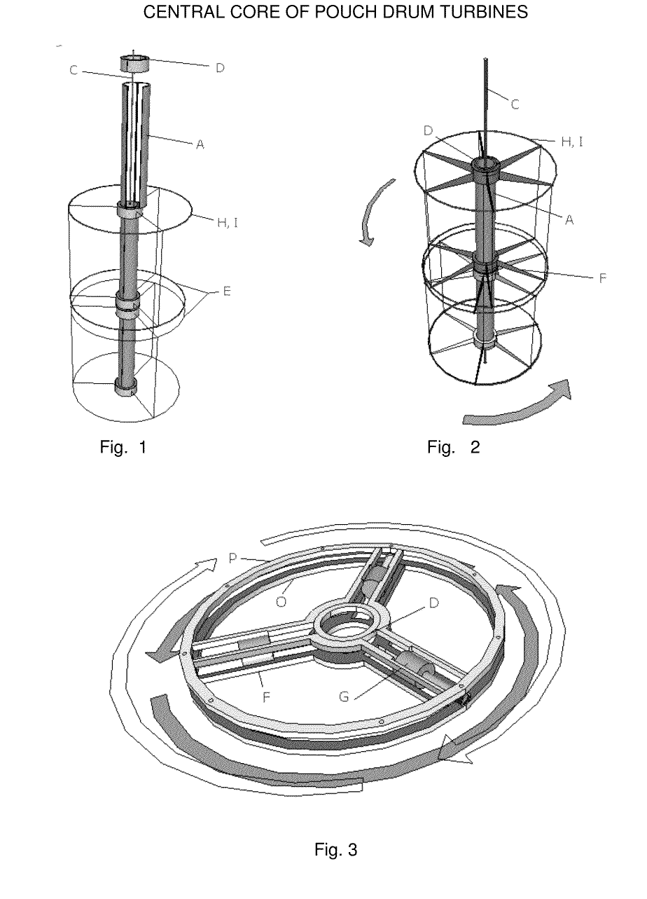

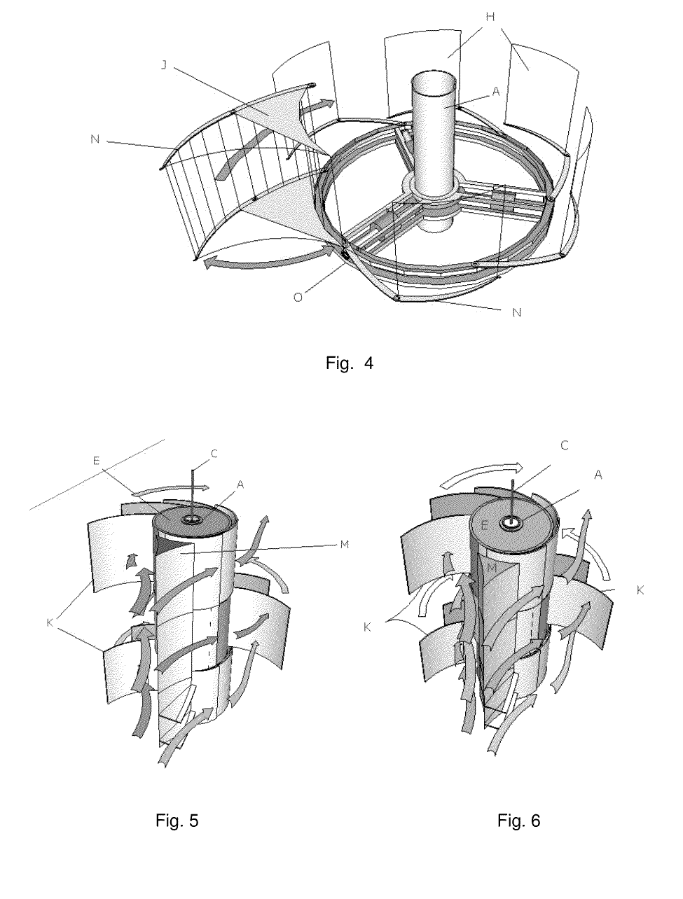

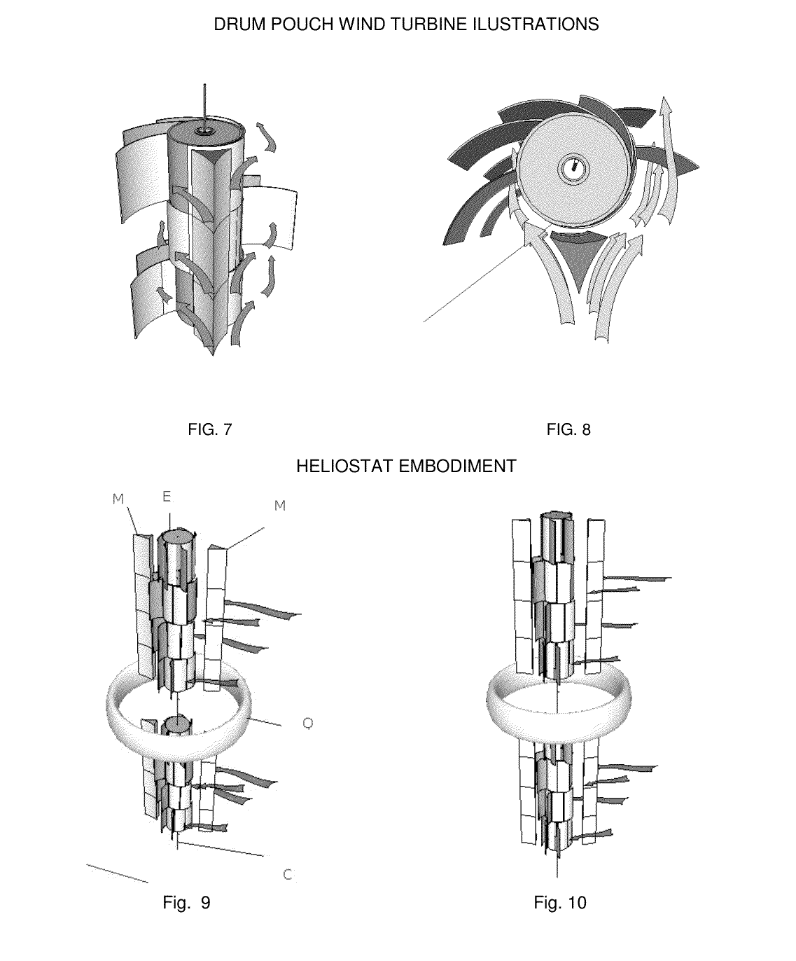

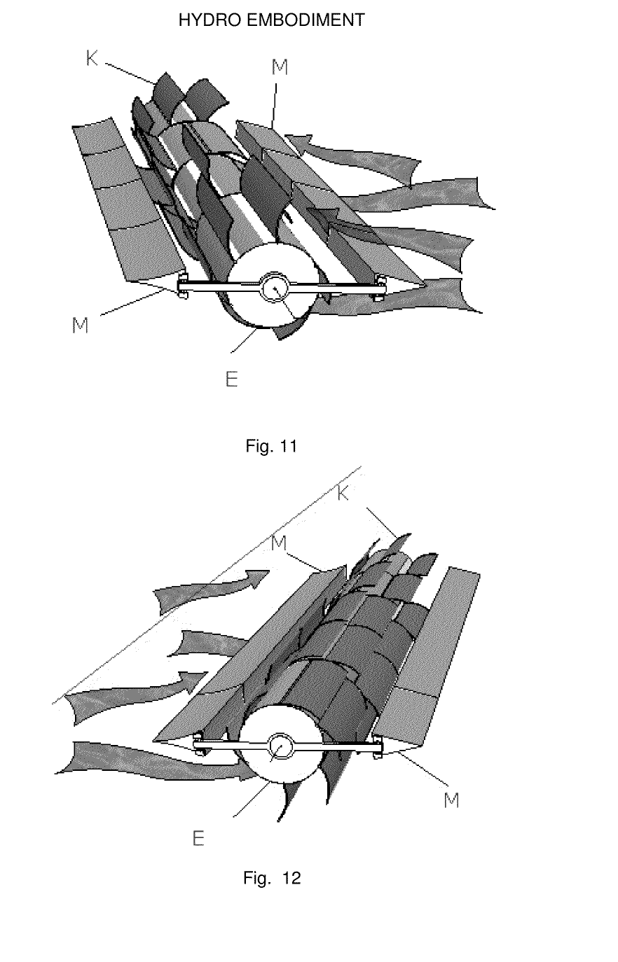

1. The system consists of drum shaped cages split in at least two parts that may be closed over existing vertical columns or over tensed cables by means of split rings, tubular jackets and wrapped with light weight fabric pouches that make these turbines light weight, easily transported, assembled, and deployed in the field.

2. One of the systems outstanding feature is: at least one pair of drum impellers may be stacked one on top of the other, the location of the generator portions on the open ends allows the system to increase power output by stacking one or more counter rotating drums, one on top of the other. The first two drums constitute the first system, but adding a third counter rotating drum with its generators would double the power, a fourth counter rotating drum would triple the power output and so on.

3. As a power boosting feature, the drums may be equipped with extendable arms with paddles or frames with sails that extend the reach of the drums on one side while retracting on the other side by the wind pressure, accelerating rotation as they retract.
This feature enlarges the wind capture area and the torque on the system, which improves power output. As each drum impeller extends the pouches or sails simultaneously, one on the right and the other on the left of the wind flow, the torque is cancelled.
